(19) United States
(12) Patent Application Publication
(10) Pub. No.: US 2003/0000304 A1
(43) Pub. Date: Jan. 2, 2003

(54) Magnetically operated fuel gauge

(76) Inventor: Clyde R. Wetor, Cascade, WI (US)

Correspondence Address: BAKER & DANIELS, 111 E. WAYNE STREET, SUITE 800, FORT WAYNE, IN, 46802

(21) Appl. No.: 09/896,540

(22) Filed: Jun. 29, 2001

(51) Int. Cl. G01F 23/56; G01F 23/30

(52) U.S. Cl. 73/305; 73/306

(57) ABSTRACT

A fuel gauge assembly for mounting to the fuel tank of a small engine which is used with a lawnmower, lawn tractor, other outdoor lawn and garden implement, or off road or sport vehicle. The fuel gauge assembly generally includes an indicator housing and a float assembly. The indicator housing is mounted exteriorly of the fuel tank and includes a movable indicator element including a magnet or a magnetically attractive material. The float assembly includes a support member mounted interiorly of the fuel tank, and further includes an arm pivotally connected to the support member, the arm including a magnet or magnetically attractive material disposed adjacent the wall and a float for sensing a level of fuel within the fuel tank. When the level of fuel in the fuel tank varies, the float changes position such that the indicator element is moved to indicate the amount of fuel in the fuel tank.

### BACKGROUND OF THE INVENTION

1. Field of the Invention

The present invention relates to fuel tanks of the type which are used on small engines for lawnmowers, lawn tractors and other outdoor lawn and garden implements, as well as for off-road and sport vehicles. In particular, the present invention relates to a fuel gauge for such fuel tanks.

2. Description of the Related Art

Engines for lawnmowers, lawn tractors, and other outdoor implements include fuel tanks for holding a volume of engine fuel, which fuel tanks are either attached directly to the engine, or are attached to the implement remote from the engine and connected thereto by a fuel line. Sometimes, such fuel tanks include a fuel gauge to allow the operator of the implement to determine the amount of fuel in the fuel tank.

For Example, one such fuel gauge includes a cylindrically-shaped fuel gauge assembly which fits within a hole in the fuel tank, and is which is sealed within the hole by adhesive, caulk, an O-ring, or a close threaded engagement between the fuel gauge assembly and the hole in the fuel tank. The fuel gauge assembly includes an indicator needle movable between empty and full positions, wherein the indicator needle is moved by a float which rotates a screw member connected to the indicator needle as the position of the float changes in order to move the needle between the empty and full positions responsive to varying fuel levels in the fuel tank.

Problematically, the foregoing fuel gauge assembly, as well as many other types of fuel gauge assemblies, require a hole in the fuel tank within which the fuel gauge assembly is fitted for attachment to the fuel tank. Although such a construction is usually not initially problematic, extended life or extended usage of the implement may give rise to the possibility of deterioration and failure of the connection between the fuel gauge assembly and the hole in the fuel tank, thereby allowing the possibility of fuel leakage.

Additionally, known fuel gauge assemblies are sometimes not mounted to the fuel tank in a manner in which they may be easily viewed by an operator during operation of the associated implement.

What is needed is a fuel gauge assembly which is an improvement over the foregoing, and which reduces the possibility of fuel leakage from the fuel tank to which the fuel gauge assembly is attached, and which may be easily viewed by an operator during operation of the associated implement.

### SUMMARY OF THE INVENTION

The present invention provides a fuel gauge assembly for mounting to the fuel tank of a small engine which is used with a lawnmower, lawn tractor, or other outdoor implement. The fuel gauge assembly generally includes an indicator housing and a float assembly. The indicator housing is mounted exteriorly of the fuel tank to an upper surface thereof, and includes a movable indicator element having either a magnet or a magnetically attractive element. The float assembly includes a support member mounted interiorly of the fuel tank, and further includes an arm movably connected to the support member, the arm including either a magnet or a magnetically attractive element which is disposed adjacent the indicator housing, and a float for sensing a level of fuel within the fuel tank. When the level of fuel in the fuel tank varies, the float changes position such that movement of the arm causes a corresponding movement of the indicator element to indicate the amount of fuel in the fuel tank.

The components of the fuel gauge assembly may be mounted to the wall of the fuel tank in a variety of ways. For example, the indicator housing may be secured to the wall of the fuel tank by an adhesive, such as an adhesive pad, and the wall may include a pair of rivet members extending interiorly within the fuel tank, upon which the support member is mounted, wherein head portions of the rivet members are then deformed to secure the support member to the wall of the fuel tank. Alternatively, the support member may be integrally formed with the wall of the fuel tank. Further, the wall of the fuel tank may include mounting bosses having threaded openings into which fasteners are tapped to secure the indicator housing and the support member to the wall of the fuel tank.

Advantageously, the present fuel gauge assembly may be mounted to the wall of a fuel tank without the need for any type of hole to be made in the wall of the fuel tank, thereby maintaining the structural integrity of the wall of the fuel tank and preventing the possibility of fuel leakage from the fuel tank through the fuel gauge assembly.

Additionally, the indicator housing is mounted to an upper surface of the fuel tank, such that the indicator housing and indicator element are easily viewed by an operator of an associated implement with which the fuel gauge assembly us used, such that the operator may easily determine the amount of fuel within the fuel tank during operation of the implement.

In one form thereof the present invention provides an internal combustion engine is provided, including an engine housing; a fuel tank connected to the engine housing, the fuel tank having an upper surface; and a fuel gauge assembly associated with the fuel tank, the fuel gauge assembly including an indicator housing connected to the upper surface of the fuel tank exteriorly of the fuel tank, the indicator housing including a moveable indicator element having one of a magnet portion and a magnetically attractive element; and a float assembly, including a support member mounted interiorly to the fuel tank and an arm movably connected to the support member, the arm including a float for sensing a level of fuel within the fuel tank, and the other of the magnet portion and the magnetically attractive element disposed opposite the one of the magnet portion and the magnetically attractive element of the indicator element, wherein when the level of fuel in the fuel tank varies, the float changes position to move the arm, thereby moving the indicator element.

In another form thereof, the present invention provides the combination of a fuel tank having an upper surface; and a fuel gauge assembly associated with the fuel tank, including an indicator housing connected to the upper surface of the fuel tank, the indicator housing including a moveable indicator element having one of a magnet portion and a magnetically attractive element; and a float assembly, including a support member mounted interiorly to the fuel tank and an arm movably connected to the support member, the arm including a float for sensing a level of fuel within the fuel tank and the other of the magnet portion and the magnetically attractive element disposed adjacent the one of the magnet portion and the magnetically attractive element of the indicator element, wherein when the level of fuel in the fuel tank varies, the float changes position to move the arm and the indicator element.

In a further form thereof, the present invention provides a fuel gauge assembly for mounting to a fuel tank which includes a substantially horizontal upper wall, the fuel gauge assembly including an indicator housing connected to the wall exteriorly of the fuel tank, the indicator housing including a moveable indicator element having one of a magnet portion and a magnetically attractive element; and a float assembly, including a support member mounted to the wall within the fuel tank and an arm movably connected to the support member, the arm including a float for sensing a level of fuel within the fuel tank and the other of the magnet portion and the magnetically attractive element disposed adjacent the one of the magnet portion and the magnetically attractive element of the indicator element, wherein when the level of fuel in the tank varies, the float changes position to move the arm and the indicator element.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a perspective view of a lawnmower, including an engine having a fuel tank to which is mounted a fuel gauge assembly in accordance with the present invention;

FIG. 1A is a top view of the engine of the lawnmower of FIG. 1, showing the indicator housing of the fuel gauge assembly mounted to the fuel tank, and further showing in dashed lines various components of the fuel gauge assembly which are located within the fuel tank;

FIG. 2 is a sectional view of one embodiment of the fuel gauge assembly of FIG. 1, taken along line 2-2 of FIG. 1;

FIG. 3 is a sectional view of another embodiment of the fuel gauge assembly of FIG. 1, taken along line 3-3 of FIG. 1; and

FIG. 4 is a sectional view of a further embodiment of the fuel gauge assembly of FIG. 1, taken along line 4-4 of FIG. 1.

Corresponding reference characters indicate corresponding parts throughout the several views. The exemplifications set out herein illustrates preferred embodiments of the invention, and such exemplifications are not to be construed as limiting the scope of the invention in any manner.

### DETAILED DESCRIPTION

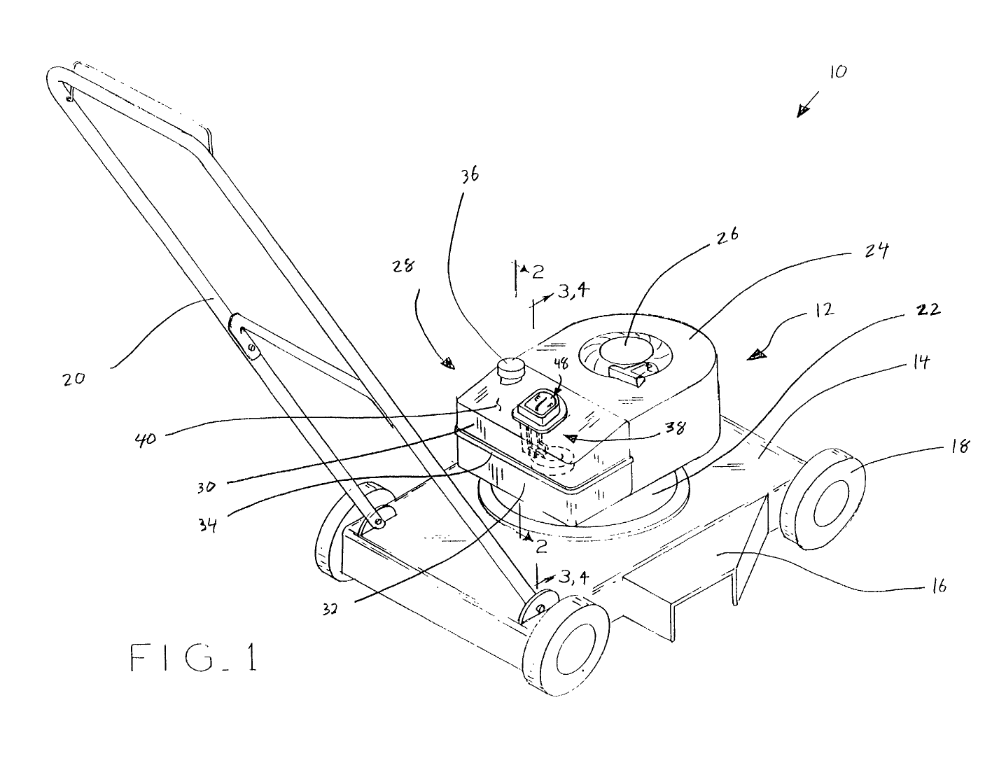

Referring to FIG. 1, lawnmower 10 is shown, including engine 12 mounted to deck 14. Deck 14 generally includes discharge chute 16, wheels 18, and handle assembly 20 connected thereto, and engine 12 generally includes a housing including crankcase 22, blower housing 24, recoil starter and blower mechanism 26, and fuel tank 28. Fuel tank 28 includes upper body portion 30 and lower body portion 32, which each may be made of a plastic material, for example, and which are sealed together at seam 34 in any suitable manner. Fuel tank 28 additionally includes fill cap 36, and fuel gauge assembly 38 mounted to a substantially horizontal upper surface 40 of wall 41 of upper body portion 30 of fuel tank 28. In FIG. 1, fuel gauge assembly 38 is shown mounted to fuel tank 28 of lawnmower 10; however, fuel gauge assembly 38 may be mounted to the fuel tank of any outdoor implement, such as a lawn tractor or a snow blower, for example, or to the fuel tank of an off-road or sport vehicle.

Referring to FIGS. 1 and 1A, it may be seen that, because fuel gauge assembly 38 is mounted to upper surface 40 of wall 41 of fuel tank 28, fuel gauge may be easily viewed by an operator of lawnmower 10 during operation thereof while the operator grasps handle assembly 20. In this connection, it may be seen that fuel gauge assembly 38 may be similarly easily viewed by operators of implements other than lawnmower 10 which include may fuel tanks similar to fuel tank 28.

Referring to FIGS. 1A-4, fuel gauge assembly 38 generally includes indicator housing 42 and float assembly 44, with indicator housing 42 mounted to wall 41 externally of fuel tank 28, and float assembly 44 shown mounted to wall 41 interiorly of fuel tank 28 opposite indicator housing 42. Indicator housing 42 includes viewing window 46, which, as shown in FIG. 1, includes markings 48 thereon corresponding to empty and full levels of fuel within fuel tank 28, as well as any level of fuel between such empty and full levels. Viewing window 46 may be glass, plexiglass, or any other suitable translucent material. However, such fuel level markings may be on lower wall 43 of indicator housing 42. Additionally, indicator housing 42 includes indicator element 50 pivotally mounted to post 51, indicator element 50 including indicator needle 52, which is adapted to point to any one of the fuel level markings on viewing window 46 or on lower wall 43 of indicator housing 42. Indicator element 50 further includes tail portion 54, which may be made of either a magnet or magnetized material, such steel, iron, cobalt, nickel, or alloy thereof, or alternatively, may be made of a magnetically attractive material such as a metal or a material having a metal incorporated therein.

Float assembly 44 includes support member 56 to which float arm 58 is movably mounted. Specifically, support member 56 may include support arms 60 having end portions 62 with apertures 64 through which pivot rod 66 is disposed to pivotally mount float arm 58 to support member 56. Float arm 58 includes insert 68 fitted within recess 70 in an upper portion thereof, which is shown disposed adjacent wall 40 opposite indicator element 50. Insert 68 may be made of a magnet or magnetized material, such steel, iron, cobalt, nickel, or alloy thereof, or alternatively, may be made of a magnetically attractive material such as a metal or a material having a metal incorporated therein. However, if tail portion 54 of indicator element 50 is made of a magnet, insert 68 should be made of a magnetically attractive material, and vice versa. Float arm 58 additionally includes float 74 attached to a lower portion thereof.

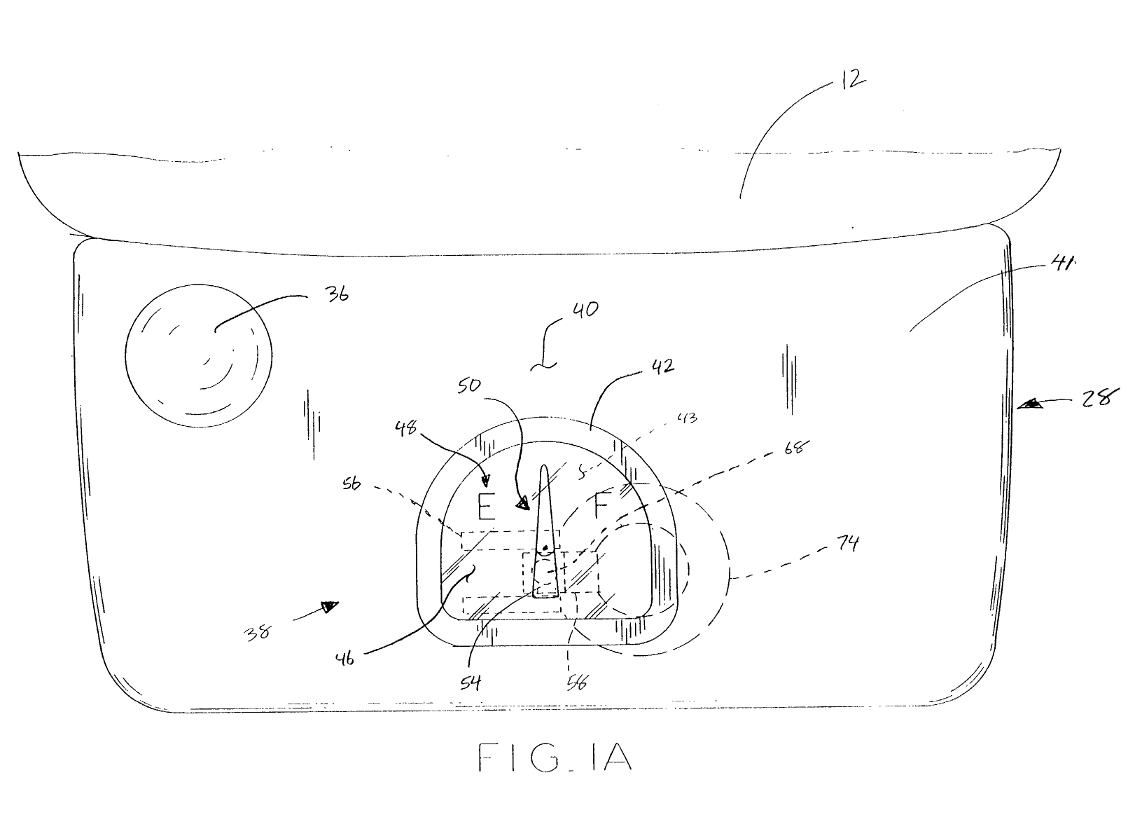

In FIGS. 2-4, various methods for attaching indicator housing 42 and float assembly 44 to wall 41 of fuel tank 28 are shown. In FIG. 2, indicator housing 42 is attached to wall 41 by an adhesive, which may be in the form of an adhesive pad 76 disposed between indicator housing 42 and wall 41. The adhesive may be a hot melt, pressure sensitive, or contact adhesive, for example. Wall 41 includes rivet members 78 depending interiorly therefrom, onto which support arms 60 of support member 56 may be fitted with rivet members 78 extending through apertures 80 in support arms 60. Thereafter, head portions 82 of rivet members 78 are deformed by heat or mechanical pressing, for example, to retain support arms 60 of support member 56 to wall 41.

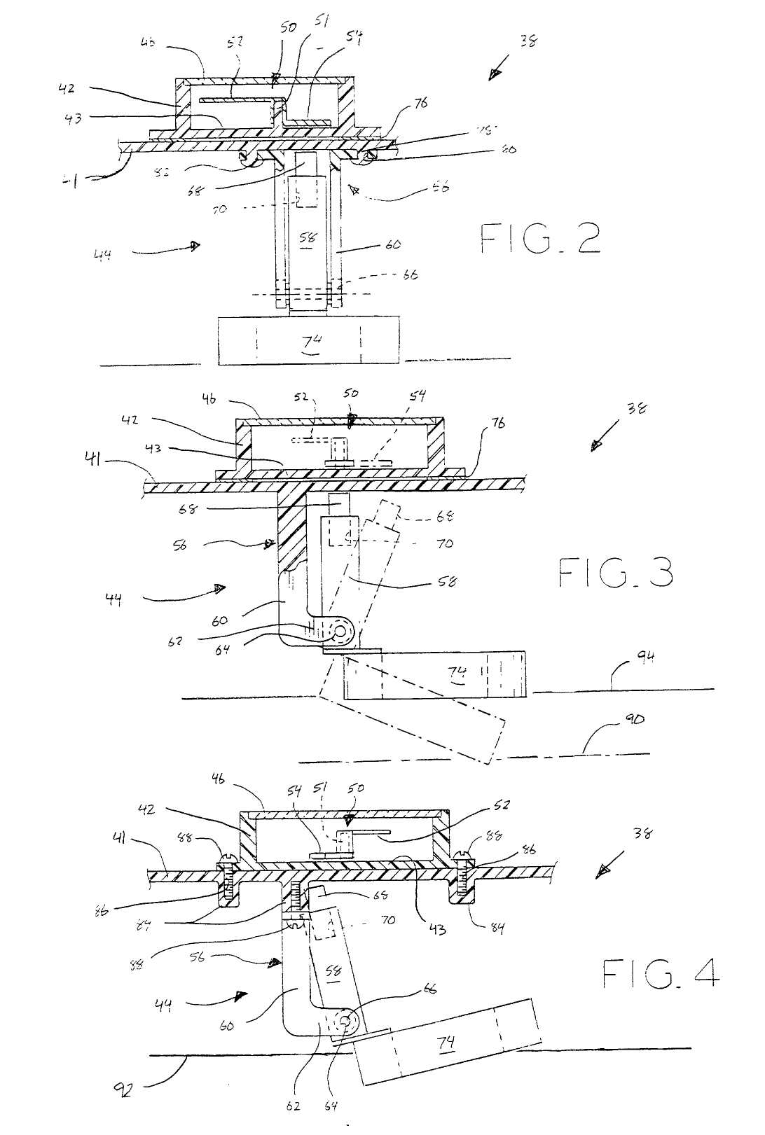

In FIG. 3, indicator housing 42 is attached exteriorly of fuel tank 28 to upper surface 40 of wall 41 of fuel tank, as described above with respect to FIG. 2 such that indicator housing is disposed beyond an outer periphery of fuel tank 28. Support member 56 is shown integrally formed with wall 41 of fuel tank 28. In FIG. 4, wall 41 includes a plurality of mounting bosses 84 with threaded openings 86 which open either exteriorly or interiorly of fuel tank 28. A plurality of fasteners 88 tap into threaded openings 86 of bosses 84 to mount indicator housing 42 and float assembly 44 to wall 41.

In each of the embodiments of FIGS. 2-4, it should be noted that each of indicator housing 42 and float assembly 44 are attached to wall 41 of fuel tank 28 without creating a hole in wall 41 of fuel tank 28. Therefore, the structural integrity of wall 41 is maintained to greatly reduce the possibility of fuel leakage from fuel tank 28 through fuel gauge assembly 38 or in the area around fuel gauge assembly 38. Further, regarding each of the embodiments of FIGS. 2-4, when fuel tank 28 is assembled, float assembly 44 may be attached to wall 41 as described above, followed by attaching upper and lower body portions 30, 32 to one another at seal 34 to enclose float assembly within fuel tank 28. Thereafter, indicator housing 42 may be attached to wall 41 of fuel tank 28 externally of fuel tank 28.

In operation, and referring to FIGS. 2-4, varying levels of fuel within fuel tank 28 cause float arm 58 to swing about pivot rod 66, and the magnetic attraction between insert 68 and tail portion 54 of indicator element 50 rotates indicator element 50 such that indicator needle 52 moves to any position between the empty and full positions of the fuel level markings on viewing window 46 or lower wall 43 of indicator housing 42. Specifically, as shown in dashed lines in FIG. 3, fuel level 90 is relatively low, and float arm 58 is pivoted by the force of gravity downwardly such that the magnetic attraction between insert 68 and tail portion 54 of indicator element 50 swings indicator needle 52 toward the “empty” fuel level marking. As shown in FIG. 4, fuel level 92 is relatively high, such that float 74 floats thereon to pivot float arm 58 upwardly, such that the magnetic attraction between insert 68 and tail portion 54 of indicator element 50 swings indicator needle 52 toward the “full” fuel level marking. Referring back to FIG. 3, as shown in solid lines therein, fuel level 94 is intermediate fuel levels 90 and 92, and float 74 is disposed such that the upper portion thereof is disposed substantially vertically, wherein the magnetic attraction between insert 68 and tail portion 54 of indicator element 50 swings indicator needle 52 to a position intermediate the “empty” and “full” fuel level markings.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An internal combustion engine, comprising:
an engine housing;
a fuel tank connected to said engine housing, said fuel tank having an upper surface; and
a fuel gauge assembly associated with said fuel tank, said fuel gauge assembly comprising:
an indicator housing connected to said upper surface of said fuel tank exteriorly of said fuel tank, said indicator housing including a moveable indicator element having one of a magnet portion and a magnetically attractive element; and
a float assembly, including a support member mounted interiorly to said fuel tank and an arm movably connected to said support member, said arm including a float for sensing a level of fuel within said fuel tank, and the other of said magnet portion and said magnetically attractive element disposed opposite said one of said magnet portion and said magnetically attractive element of said indicator element, wherein when the level of fuel in said fuel tank varies, said float changes position to move said arm, thereby moving said indicator element.

2. The engine of claim 1, wherein said fuel tank includes an outer periphery, and said indicator housing is disposed outwardly of said outer periphery.

3. The engine of claim 1, wherein said fuel tank includes an upper wall, and said indicator housing is connected exteriorly to said upper wall.

4. The engine of claim 3, wherein said support member is connected to said upper wall interiorly of said fuel tank and opposite said indicator housing.

5. The engine of claim 1, wherein said fuel tank includes at least one threaded protruding portion, and at least one of said indicator housing and said support member is mounted to said fuel tank by at least one fastener which taps into a respective threaded protruding portion.

6. The engine of claim 1, further including an adhesive disposed intermediate said indicator housing and said fuel tank to thereby secure said indicator housing to said fuel tank.

7. The engine of claim 1, wherein said support member is integrally formed with said fuel tank.

8. The engine of claim 1, wherein said fuel tank includes at least one stake protruding interiorly therefrom and having a head portion, and said support member includes at least one aperture therein, each said stake disposed through a respective said aperture with each said head portions deformed about each said aperture to secure said support member to said fuel tank.

9. In combination:
a fuel tank having an upper surface; and
a fuel gauge assembly associated with said fuel tank, comprising:
an indicator housing connected to said upper surface of said fuel tank, said indicator housing including a moveable indicator element having one of a magnet portion and a magnetically attractive element; and
a float assembly, including a support member mounted interiorly to said fuel tank and an arm movably connected to said support member, said arm including a float for sensing a level of fuel within said fuel tank and the other of said magnet portion and said magnetically attractive element disposed adjacent said one of said magnet portion and said magnetically attractive element of said indicator element, wherein when the level of fuel in said fuel tank varies, said float changes position to move said arm and said indicator element.

10. The combination of claim 9, wherein said fuel tank includes an outer periphery, and said indicator housing is disposed outwardly of said outer periphery.

11. The combination of claim 9, wherein said fuel tank includes at least one threaded protrusing portion, and at least one of said indicator housing and said support member is mounted to said fuel tank by at least one fastener which taps into a respective threaded protruding portion.

12. The combination of claim 9, further including an adhesive disposed intermediate said indicator housing and said fuel tank to thereby secure said indicator housing to said fuel tank.

13. The combination of claim 9, wherein said support member is integrally formed with said fuel tank.

14. The combination of claim 9, wherein said fuel tank includes at least one stake protruding interiorly therefrom and having a head portion, and said support member includes at least one aperture therein, each said stake disposed through a respective said aperture with each said head portions deformed about each said aperture to secure said support member to said fuel tank.

15. A fuel gauge assembly for mounting to a fuel tank which includes a substantially horizontal upper wall, said fuel gauge assembly comprising:
an indicator housing connected to the wall exteriorly of the fuel tank, said indicator housing including a moveable indicator element having one of a magnet portion and a magnetically attractive element; and
a float assembly, including a support member mounted to the wall within the fuel tank and an arm movably connected to said support member, said arm including a float for sensing a level of fuel within the fuel tank and the other of said magnet portion and said magnetically attractive element disposed adjacent said one of said magnet portion and said magnetically attractive element of said indicator element, wherein when the level of fuel in the tank varies, said float changes position to move said arm and said indicator element.
